(19) United States
(12) Patent Application Publication
(10) Pub. No.: US 2026/0203112 A1
(43) Pub. Date: Jul. 16, 2026

(54) DATA TRANSMISSION METHOD, DEVICE AND NON-TRANSITORY COMPUTER-READABLE STORAGE MEDIUM

(71) Applicant: BYTEDANCE TECHNOLOGY LTD., Grand Cayman (KY)

(72) Inventors: Zhe JIANG, Los Angeles, CA (US); Jinlai XU, Los Angeles, CA (US); Chenggang LAI, Los Angeles, CA (US); Wei XU, Los Angeles, CA (US); Shiyang CHEN, Los Angeles, CA (US)

(21) Appl. No.: 19/025,698

(22) Filed: Jan. 16, 2025

(51) Int. Cl. G06F 9/50; G06F 15/173; G06F 17/16

(52) U.S. Cl. CPC G06F 9/5016; G06F 15/17331; G06F 17/16

(57) ABSTRACT

This disclosure relates to a data transmission method, device and a non-transitory computer-readable storage medium. The data transmission method, including: calculating KV cache as a data block to be transmitted using a prefill worker of a machine learning model; and transmitting, using RDMA, the data block to be transmitted from a GPU of the Prefill worker to a GPU of a decode worker of the machine learning model.

### TECHNICAL FIELD

The present disclosure relates to the field of computer technologies, and in particular, to a data transmission method, a data transmission device, and a non-transitory computer-readable storage medium.

### BACKGROUND

Machine learning models with language processing and generation capabilities have become foundational to many applications and are now a critical workload in data centers. While advancements in model architectures focus on improving response quality, it is equally important to ensure that these models can be served efficiently at scale and at a low cost.

In the related art, a machine learning model inference service(online) is deployed in training clusters to maximize the utilization of the hardware resource which can be shared with the training tasks (offline). Most machine learning model inference services are either deployed to single host or multiple hosts. For multiple hosts deployment, the current practice relies on pipeline parallel to transmit KV(Key tensor and Value tensor) Cache (tensor parallel) via regular NIC(Network Interface Controller).

### SUMMARY

According to some embodiments of the present disclosure, there is provided a data transmission method, including: calculating KV cache as a data block to be transmitted using a prefill worker of a machine learning model; and transmitting, using RDMA(Remote Direct Memory Access), the data block to be transmitted from a GPU(Graphics Processing Unit) of the Prefill worker to a GPU of a decode worker of the machine learning model.

In some embodiments, the transmitting, using the RDMA, the data block to be transmitted from the GPU of the Prefill worker to the GPU of the decode worker of the machine learning mode including: translating a transmission of the KV cache into an RDMA transaction based on an ID of the data block to be transmitted; and implementing the RDMA transaction using an RDMA verb to transmit the data block to be transmitted to the GPU of the decode worker.

In some embodiments, the translating the transmission of the KV cache into the RDMA transaction based on the ID of the data block to be transmitted including: merging the data blocks to be transmitted with adjacent IDs into one data block to be transmitted.

In some embodiments, the merging the data blocks to be transmitted with adjacent IDs into the one data block to be transmitted comprising: calculating a boundary of each data block of the data blocks to be transmitted with adjacent IDs; and merging the data blocks to be transmitted with adjacent IDs into the one data block to be transmitted, according to the boundary of the each data block.

In some embodiments, the transmitting, using the RDMA(remote direct memory access), the data block to be transmitted from the GPU of the Prefill worker to the GPU of the Decode worker of the machine learning mode including: allocating a first store position in a video memory, using the decode worker; and obtaining, through the RDMA, the KV cache from the first store position using the decode worker.

In some embodiments, the obtaining, through the RDMA, the KV cache from the first store position using the decode worker including: sending relevant information of the first store position to the prefill worker; and writing, through the RDMA, the KV cache stored in a second store position of the video memory, to the first store position using the prefill worker.

In some embodiments, the obtaining, through the RDMA, the KV cache from the first store position using the decode worker including: sending relevant information of a second store position allocated by the prefill worker to the decode worker, the second store position being for storing cached data of the KV cache; and reading the KV cache from the second store position to the first store position through the RDMA using the decode worker.

In some embodiments, the first store position is allocated by the decode worker according to prompt information input into the machine learning model, the second store position is allocated by the prefill worker according to the prompt information, and the sending the relevant information of the first store position to the prefill worker including: sending the prompt information and an ID of the first store position to the prefill worker using the decode worker.

In some embodiments, the second store position is allocated by the prefill worker according to prompt information input to the machine learning model.

some embodiments, the video memory is registered by using a NIC supporting th RDMA.

In some embodiments, the data transmission method, further including: establishing a connection between a transmission initiating unit of the machine learning model and a transmission response unit of the machine learning model using the transmission initiating unit, the transmission initiating unit being the prefill worker or the decode worker, and the transmission response unit being the prefill worker or the decode worker; and sending, using the transmission response unit, metadata of the KV cache to the transmission initiating unit.

In some embodiments, the data transmission method, further including: notifying, in response to a completion of a transmission of the data block to be transmitted, a transmission responding unit of the machine learning model that the completion of the transmission, using a transmission initiating unit of the machine learning model.

According to other embodiments of the present disclosure, there is provided a data transmission device, including: a memory; and a processor coupled to the memory, the processor configured to perform, based on instructions stored in the memory, a data transmission method, including: calculating KV cache as a data block to be transmitted using a prefill worker of a machine learning model; and transmitting, using RDMA, the data block to be transmitted from a GPU of the Prefill worker to a GPU of a decode worker of the machine learning model.

According to still other embodiments of the present disclosure, there is provided a non-transitory computer-readable storage medium storing computer instructions, wherein the computer instructions are used to cause a computer to perform a data transmission method, including: calculating KV(Key tensor and Value tensor) cache as a data block to be transmitted using a prefill worker of a machine learning model; and transmitting, using RDMA(Remote Direct Memory Access), the data block to be transmitted from a GPU (Graphics Processing Unit) of the Prefill worker to a GPU of a decode worker of the machine learning model.

Other features, aspects, and advantages of the present disclosure will become apparent from the following detailed description of exemplary embodiments thereof, which is made with reference to the accompanying drawings.

### BRIEF DESCRIPTION OF THE DRAWINGS

Preferred embodiments of the present disclosure are described below with reference to the accompanying drawings. The accompanying drawings described herein are used for providing a further understanding of the present disclosure. The accompanying drawings, together with the following specific description, are incorporated in and form a part of this specification, and serve to explain the present disclosure. It should be understood that the drawings in the following description relate to only some embodiments of the disclosure and do not constitute limitations on the present disclosure. In the drawings:

FIG. 1 shows a flowchart of some embodiments of the data transmission method of the present disclosure;

FIG. 2 shows a schematic diagram of some embodiments of the data transmission method of the present disclosure;

FIGS. 3a to 3b show schematic diagrams of other embodiments of the data transmission method of the present disclosure;

FIG. 4 shows a schematic diagram of still other embodiments of the data transmission method of the present disclosure;

FIG. 5 shows a block diagram of some embodiments of the data transmission device of the present disclosure; and

FIG. 6 shows a block diagram of other embodiments of the data transmission device of the present disclosure.

It should be understood that sizes of various components shown in the drawings are not necessarily drawn to actual scale for ease of description. Identical or similar reference numbers are used in the drawings to refer to identical or similar components. Therefore, once a certain item is defined in one drawing, it may not be further discussed in subsequent drawings.

### DETAILED DESCRIPTION

Various exemplary embodiments of the present disclosure will now be described in detail with reference to the accompanying drawings. Notice that, Unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an article is defined in a drawing, there is no need for further discussion in the accompanying drawings.

The inventors of the present disclosure have found the following problem existed in the related art: high latency of the computer inference leads to low efficiency in data processing.

In view of this, the present disclosure provides a technical solution for data transmission, which can reduce the latency of the computer inference to promote the efficiency in data processing.

As mentioned above, for single host deployment, the decode phase may block the prefill phase and increase the inference request latency; and the latency for pipeline parallel is high due to distributing NN(Neural Network) layers to separate hosts, which impact the throughput of the inference service.

On the other hand, transmitting KV cache from prefill workers to decode workers is considered as the major bottleneck in disaggregated machine learning model inference. Transmitting the KV Cache via regular NIC may impact the requests from customers due to limited bandwidth, which leads to low efficiency in data processing.

In view of the above technical problem, the present disclosure provides a technical solution for data transmission. Since the servers in training clusters may configure NIC supporting RDMA along with GPU, and the bandwidth for these NICs are way larger than the regular NIC above, relying on the GPU Directed RDMA to transmit the KV cache, and leaving the regular NIC to serve customers requests (or other control or dataflow) may reduce the latency of the computer inference to promote the efficiency in data processing.

For example, the technical solutions of the present disclosure may be illustrated by the following embodiments.

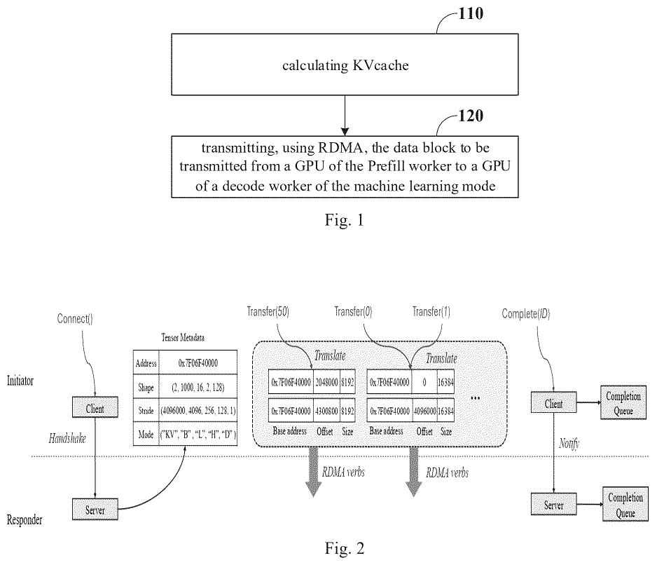

FIG. 1 shows a flowchart of some embodiments of the data transmission method of the present disclosure.

As shown in FIG. 1, in step 110, calculating KV cache as a data block to be transmitted using a prefill worker of a machine learning model. For example, the machine learning model is a machine learning models with language processing and generation capabilities; and the machine learning mode includes a prefill worker and a decoder worker.

For example, prefill worker is configured to generate a part of the output (i.e. token) based on the prompt input to the model before the model generates the text and store the intermediate result into KV cache for subsequent inference process. Through such prefill, the computational latency in real-time text generation can be reduced and the response speed of the model can be improved. Prefill worker may be implemented using computers deployed in a cluster.

For example, the decode worker is configured to generate text corresponding to the input prompt based on the KV cache. Decode worker may be implemented using computers deployed in a cluster.

In some embodiments, before the transmission of the KV cache, a connection between a transmission initiating unit of the machine learning model and a transmission response unit of the machine learning model is established using the transmission initiating unit, the transmission initiating unit being the prefill worker or the decode worker, and the transmission response unit being the prefill worker or the decode worker; and metadata of the KV cache is sent to the transmission initiating unit, using the transmission response unit.

For example, the initiator (i.e. transmission initiating unit) establishes a connection with the responder (i.e. transmission response unit) through a handshake process. The initiator runs a KVDirect-transport client that connects to the KVDirect-transport server on the responder. Once the QP(Queue Pair) is established, the responder sends the metadata of the KV cache to the initiator. This metadata may include the tensor's Address, Shape, Stride, and Mode, which reflect the memory layout determined by the attention kernels; the Mode may include “KV” for the K and V tensors, “B” for KV cache blocks, “L” for the number of tokens per block, “H” for the attention head, and “D” for the hidden dimension. If there are multiple KV cache tensors, the metadata for each tensor may be sent separately during this step. This connection operation above may be performed once for each connection.

In step 120, transmitting, using RDMA, the data block to be transmitted from a GPU of the Prefill worker to a GPU of a decode worker of the machine learning model.

In the above embodiment, the KV cache is transmitted from the prefill worker to the decode worker via RDMA. Thus, direct access between GPUs is realized using RDMA, which reduces the latency of the computer's inference and improves the efficiency of the computer's data processing.

In the following, a technical solution for transmitting a KV cache via RDMA is exemplary illustrated using some embodiments in FIG. 2.

FIG. 2 shows a schematic diagram of some embodiments of the data transmission method of the present disclosure.

As shown in FIG. 2, the initiator may transmit the KV cache to the responder through CONNECT( ) operation, TRANSFER( ) operation, and COMPLETE( ) operation.

In the CONNECT( ) operation, the initiator establishes a connection with the responder through a handshake process. The initiator runs a KVDirect-transport client that connects to the KVDirect-transport server on the responder. Once the QP is established, the responder sends the metadata of the KV cache to the initiator. This metadata includes the KV cache's Address, Shape, Stride, and Mode, which reflect the memory layout determined by the attention kernels. For example, the Mode may include “KV” for the K and V tensors, “B” for KV cache blocks, “L” for the number of tokens per block, “H” for the attention head, and “D” for the hidden dimension. If there are multiple KV cache tensors, the metadata for each tensor is sent separately during this operation. The CONNECT( ) operation only needs to be performed once for each connection.

As shown in FIG. 2, After establishing the connection, the initiator may perform a TRANSFER( ) operation to send and receive blocks from the responder. The initiator transmits KV caches by invoking TRANSFER( ) operation with a specified block ID, which is then translated into an RDMA transaction. For example, transmitting block 50(i.e. specified block ID is 50) results in two separate RDMA transactions because the K and V tensors are stored in disjoint positions. Each transaction is 8192 bytes if using bfloat16, includes the “L”,“H”, and “D” modes.

In some embodiments, the data blocks to be transmitted with adjacent IDs may be merged into one data block to be transmitted. As shown in FIG. 2, as an example, for adjacent blocks, such as those accessed by TRANSFER(0) (i.e. specified block ID is 0) and TRANSFER(1) (i.e. specified block ID is 1), the blocks are merged so that each transaction for K and V transfers 16384 bytes.

For example, a boundary of each data block of the data blocks to be transmitted with adjacent IDs is calculated; and the data blocks to be transmitted with adjacent IDs into the one data block to be transmitted is merged, according to the boundary of the each data block.

In the above embodiments, considering that the blocks in the KV Cache are discrete, the boundary of each block is automatically calculated, and the small blocks are merged into a large block, which increases the transmission efficiency by making the transmission memory area larger.

In some embodiments, a transmission of the KV cache may be translated into an RDMA transaction based on an ID of the data block to be transmitted; and the RDMA transaction is implemented using an RDMA verb to transmit the data block to be transmitted to the GPU of the decode worker. For example, a RDMA verb may be a RDMA interface, such as RDMA read verb and/or write verb.

As shown in FIG. 2, as an example, these transactions are then issued to KVDirect-transport using RDMA verbs. Thus, the efficiency of the transmission can be improved. For example, the user can use RDMA write and read by specifying WRITE( ) and READ( ), respectively.

In some embodiments, in response to a completion of a transmission of the data block to be transmitted, a transmission responding unit of the machine learning model is notified that the completion of the transmission, using a transmission initiating unit of the machine learning model.

As shown in FIG. 2, The COMPLETE( ) operation is configured to signal the completion of a request. In response to all blocks for a request being transmitted, the initiator invokes COMPLETE( ) operation with the corresponding request ID. The KVDirect-transport client then notifies the KVDirect-transport server on the responder. In response to the notification being sent, both the initiator and responder notify the inference engine the completion of the request.

In the above embodiments, compared with the message-based KV cache transmission the overhead is reduced. For example, the initiator sends all blocks of the request and notifies the responder; and the responder waits the request to complete asynchronously and free the blocks. Compared with the message-basing transfer, the above embodiments avoid the CPU communication and CUDA(Compute Unified Device Architecture) operations so that the latency of the computer's inference is reduced and the efficiency of the computer's data processing improved.

In the following, a technical solution for allocating store position on decode and prefill workers to avoid the data race on KV cache is exemplary illustrated using some embodiments.

In some embodiments, a first store position in a video memory is allocated, using th decode worker; and the KV cache is obtained from the first store position using the decode worker, through the RDMA.

For example, the video memory of all the GPUs is registered by using a NIC supporting the RDMA. Thus, using the NIC supporting RDMA to register the video memory of all GPUs directly avoids the Gather/Scatter method, which improves the computer processing efficiency.

In some embodiments, relevant information of the first store position is sent to the prefill worker; and the KV cache stored in a second store position of the video memory is written to the first store position using the prefill worker, through the RDMA. For example, the first store position is allocated by the decode worker according to prompt information input into the machine learning model, the second store position is allocated by the prefill worker according to the prompt information, and the prompt information and an ID of the first store position is sent to the prefill worker using the decode worker.

In some embodiments, relevant information of a second store position allocated by the prefill worker is sent to the decode worker, the second store position being for storing cached data of the KV cache; and the KV cache is read from the second store position to the first store position through the RDMA using the decode worker. For example, the second store position is allocated by the prefill worker according to prompt information input to the machine learning model.

In the above embodiments, the KV cache is sent and received in place, it needs to avoid the data race on KV cache blocks. To achieve this, the above embodiments employ a scheduler on both the decode and prefill workers, responsible for allocating the store positions for each request. In the beginning, both workers allocate the store positions based on the length of the prompt. During token generation, the scheduler on the decode worker allocates and appends new store positions as needed. Therefore, the scheduler ensures the store positions are only used by the associated request so that the data race is avoid and the efficiency of the computer's data processing is improved.

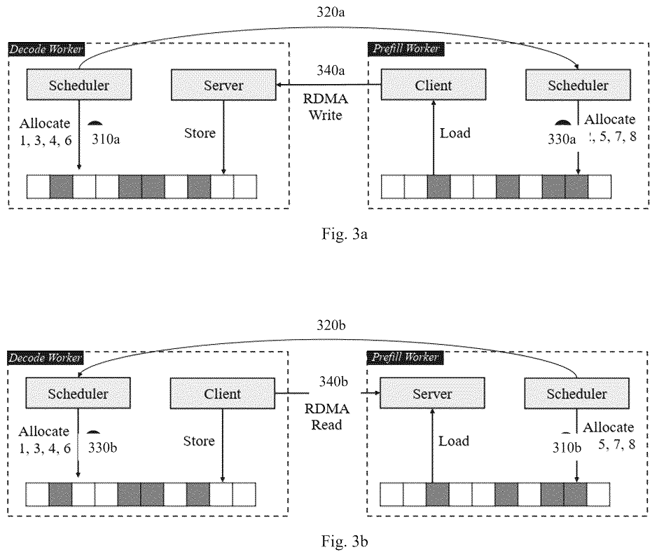

In the following, a technical solution for allocating store position on decode and prefill workers is exemplary illustrated using some embodiments in FIGS. 3a to 3d.

FIGS. 3a to 3b show schematic diagrams of other embodiments of the data transmission method of the present disclosure.

As shown in FIGS. 3a and 3b, there are two types of transmission patterns: push-mode(shown in FIG. 3a) and pull-mode(shown in FIG. 3b).

As shown in FIG. 3a, in push-mode, the prefill worker may push the KV cache to the decode worker. In step 310 a, the decode worker allocates 4 blocks(i.e. first store positions) for the prompt. In step 320a, the decode worker sends the prompt and the block IDs(i.e. relevant information, such as 1, 3, 4, 6) to the prefill worker. In step 330 a, the prefill worker allocates the blocks(i.e. second store positions, such as 2, 5, 7, 8) for the prompt, and store the KV cache calculated in these blocks as filled blocks. In step 340a, the KVDirect-transport client on the prefill worker writes the filled blocks to the decode worker based on the received block IDs.

As shown in FIG. 3b, the pull-mode instead lets the decode worker read from the prefill worker. In step 310b, the prefill worker first allocates the blocks(i.e. second store positions) for the prompt and then performs the prefill computation, the KV cache calculated stored in these blocks as filled blocks. In step 320b, the block IDs(such as 2, 5, 7, 8) of the filled blocks are sent to the decode worker. In step 330b, the decode worker allocates the blocks(i.e. first store positions). In step 340b, the KVDirect-transport client on the decode worker reads the blocks (i.e. 2, 5, 7, 8) on the prefill worker via RDMA. Since the block IDs are sent after the computation, the read blocks must be filled. For example, the pull-mode due may be defaulted to its more efficient resource utilization, primarily because of its shorter KV cache lifetimes on both the decode and prefill workers.

In the above embodiments, KVDirect-transport is a transport-layer communication library supporting the tensor communication in KVDirect. The KVDirect-transport is designed and implemented with three features: first, it supports dynamic inter-node communication where the connection can be established ad-hoc without complex collective initialization; second, it implements the tensor communication as described above; and third, it presents low CPU overhead and accommodates the existing software stack.

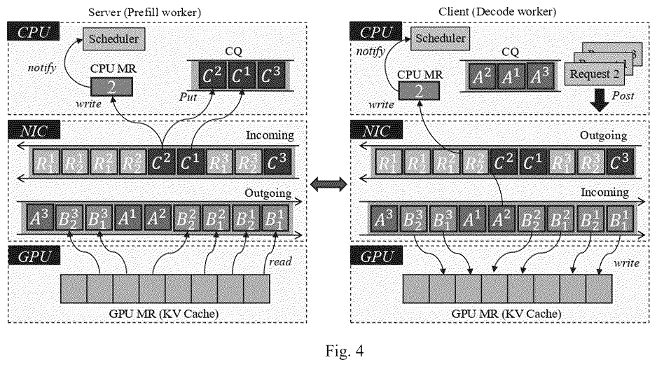

In the following, a technical solution for tensor communication protocol and KVDirect-transport using RDMA read and write verbs to transmit the KV cache are exemplary illustrated using some embodiments in FIG. 4.

FIG. 4 shows a schematic diagram of still other embodiments of the data transmission method of the present disclosure.

FIG. 4 shows an example of KV cache communication, where the KV cache of request 1, 2 and 3 is transmitted using pull-mode. On the client side, the request i posts three RDMA verbs on the client: two RDMA read (Rᵢ¹ and Rᵢ²) for KV cache and one RDMA write for completion message(Cᵢ). The request ID is copied into the CPU MR and read by the NIC as the completion message. The order of RDMA operations within a single request is preserved naturally by the QP, ensuring that the completion message is always issued after the related RDMA read operations. However, operations from different requests can be issued out-of-order, as they may operate on the QP concurrently.

As shown in FIG. 4, on the server side, the NIC processes the operations according to their type. For KV cache blocks of request i, the NIC reads the KV cache on the GPU based on the specified offset and size, returning two responses (Bᵢ¹ and Bᵢ²) which write the KV cache content to the specified locations on the client. The NIC writes the request ID into the CPU MR for the completion message. This request ID is sent with an immediate value placed into the CQ upon receiving it. If the server polls the CQ and retrieves the immediate value, it signals that the request ID has been written and the KV cache transmission for request i is complete. The server then notifies the scheduler with the request ID and posts an RDMA write (Aⁱ) to return the request ID to the client, confirming the CPU MR usage is done. If the client polls the CQ and receives the confirmation, it can post the completion message for the next request in the queue and notify its scheduler that the request i is complete. As a result, the communication of completion messages is blocking to prevent write-after-write conflicts in the CPU MR. Besides, the RDMA operations for KV cache are non-blocking and can be continuously posted to maximize bandwidth utilization.

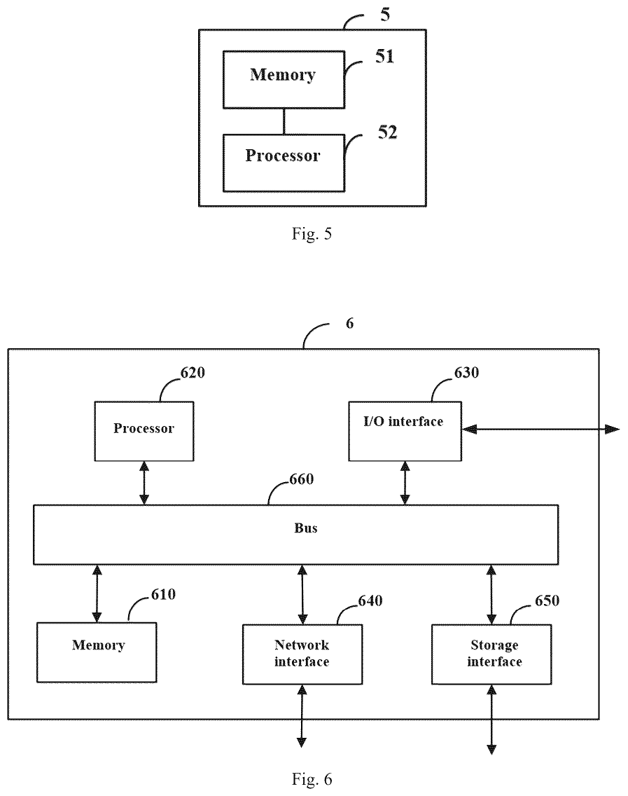

FIG. 5 shows a block diagram of some embodiments of the data transmission device of the present disclosure.

As shown in FIG. 5, the data transmission device 5 of the embodiments include: memory 51 and a processor 52 coupled to the memory 51, the processor 52 configured to, based on instructions stored in the memory 51, carry out the data transmission method according to any one of the embodiments of the present disclosure.

Wherein, the memory 61 may include, for example, system memory, a fixed non-transitory storage medium, or the like. The system memory stores, for example, an operating system, applications, a boot loader, a database, and other programs.

FIG. 6 shows a block diagram of other embodiments of the data transmission device of the present disclosure.

As shown in FIG. 6, the data transmission device 6 of the embodiments include: memory 610 and a processor 620 coupled to the memory 610, the processor 620 configured to, based on instructions stored in the memory 610, carry out the data transmission method according to any one of the embodiments of the present disclosure.

The memory 610 may include, for example, system memory, a fixed non-transitory storage medium, or the like. The system memory stores, for example, an operating system, application programs, a boot loader (Boot Loader), and other programs.

The data transmission device 6 may further include an input-output interface 630, a network interface 640, a storage interface 650, and the like. These interfaces 630, 640, 650 and the memory 610 and the processor 620 may be connected through a bus 660, for example. Wherein, the input-output interface 630 provides a connection interface for input-output devices such as a display, a mouse, a keyboard, a touch screen, a microphone, a loudspeaker, etc. The network interface 640 provides a connection interface for various networked devices. The storage interface 650 provides a connection interface for external storage devices such as an SD card and a USB flash disk.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical memory, etc.) having computer-usable program code embodied therein.

Heretofore, the data transmission method, the data transmission device, and the non-transitory computer-readable storage medium according to the present disclosure have been described in detail. In order to avoid obscuring the concepts of the present disclosure, some details known in the art are not described. Based on the above description, those skilled in the art can understand how to implement the technical solutions disclosed herein.

The method and system of the present disclosure may be implemented in many ways. For example, the method and system of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which include machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is

1. A data transmission method, comprising:
calculating KV(Key tensor and Value tensor) cache as a data block to be transmitted using a prefill worker of a machine learning model; and
transmitting, using Remote Direct Memory Access(RDMA), the data block to be transmitted from a Graphics Processing Unit (GPU) of the Prefill worker to a GPU of a decode worker of the machine learning model.

2. The data transmission method according to claim 1, wherein the transmitting, using the Remote Direct Memory Access (RDMA), the data block to be transmitted from the Graphics Processing Unit (GPU) of the Prefill worker to the GPU of the decode worker of the machine learning mode comprising:
translating a transmission of the KV cache into an RDMA transaction based on an ID of the data block to be transmitted; and
implementing the RDMA transaction using an RDMA verb to transmit the data block to be transmitted to the GPU of the decode worker.

3. The data transmission method according to claim 2, wherein the translating the transmission of the KV cache into the RDMA transaction based on the ID of the data block to be transmitted comprising:
merging the data blocks to be transmitted with adjacent IDs into one data block to be transmitted.

4. The data transmission method according to claim 1, wherein, the merging the data blocks to be transmitted with adjacent IDs into the one data block to be transmitted comprising:
calculating a boundary of each data block of the data blocks to be transmitted with adjacent IDs; and
merging the data blocks to be transmitted with adjacent IDs into the one data block to be transmitted, according to the boundary of the each data block.

5. The data transmission method according to claim 1, wherein the transmitting, using the RDMA(remote direct memory access), the data block to be transmitted from the Graphics Processing Unit(GPU) of the Prefill worker to the GPU of the Decode worker of the machine learning mode comprising:
allocating a first store position in a video memory, using the decode worker; and obtaining, through the RDMA, the KV cache from the first store position using the decode worker.

6. The data transmission method according to claim 5, wherein the obtaining, through the RDMA, the KV cache from the first store position using the decode worker comprising:
sending relevant information of the first store position to the prefill worker; and
writing, through the RDMA, the KV cache stored in a second store position of the video memory, to the first store position using the prefill worker.

7. The data transmission method according to claim 5, wherein the obtaining, through the RDMA, the KV cache from the first store position using the decode worker comprising:
sending relevant information of a second store position allocated by the prefill worker to the decode worker, the second store position being for storing cached data of the KV cache; and
reading the KV cache from the second store position to the first store position through the RDMA using the decode worker.

8. The data transmission method according to claim 6, wherein the first store position is allocated by the decode worker according to prompt information input into the machine learning model, the second store position is allocated by the prefill worker according to the prompt information, and
the sending the relevant information of the first store position to the prefill worker comprising:
sending the prompt information and an ID of the first store position to the prefill worker using the decode worker.

9. The data transmission method according to claim 7, wherein the second store position is allocated by the prefill worker according to prompt information input to the machine learning model.

10. The data transmission method according to claim 5, wherein the video memory is registered by using a Network Interface Controller(NIC) supporting the RDMA.

11. The data transmission method according to claim 1, further comprising:
establishing a connection between a transmission initiating unit of the machine learning model and a transmission response unit of the machine learning model using the transmission initiating unit, the transmission initiating unit being the prefill worker or the decode worker, and the transmission response unit being the prefill worker or the decode worker; and
sending, using the transmission response unit, metadata of the KV cache to the transmission initiating unit.

12. The data transmission method according to claim 1, further comprising:
notifying, in response to a completion of a transmission of the data block to be transmitted, a transmission responding unit of the machine learning model that the completion of the transmission, using a transmission initiating unit of the machine learning model.

13. A data transmission device, comprising:
a memory; and
a processor coupled to the memory, the processor configured to perform, based on instructions stored in the memory, a data transmission method, comprising:
calculating KV(Key tensor and Value tensor) cache as a data block to be transmitted using a prefill worker of a machine learning model; and
transmitting, using Remote Direct Memory Access(RDMA), the data block to be transmitted from a Graphics Processing Unit(GPU) of the Prefill worker to a GPU of a decode worker of the machine learning model.

14. The data transmission device according to claim 13, wherein the processor is configured to perform following steps:
translating a transmission of the KV cache into an RDMA transaction based on an ID of the data block to be transmitted; and
implementing the RDMA transaction using an RDMA verb to transmit the data block to be transmitted to the GPU of the decode worker.

15. The data transmission device according to claim 14, wherein the processor is configured to perform a following step:
merging the data blocks to be transmitted with adjacent IDs into one data block to be transmitted.

16. The data transmission device according to claim 13, wherein the processor is configured to perform following steps:
calculating a boundary of each data block of the data blocks to be transmitted with adjacent IDs; and
merging the data blocks to be transmitted with adjacent IDs into the one data block to be transmitted. according to the boundary of the each data block.

17. The data transmission device according to claim 13, wherein the processor is configured to perform following steps:
allocating a first store position in a video memory, using the decode worker; and
obtaining, through the RDMA, the KV cache from the first store position using the decode worker.

18. The data transmission device according to claim 17 wherein the processor is configured to perform following steps:
sending relevant information of the first store position to the prefill worker; and
writing, through the RDMA, the KV cache stored in a second store position of the video memory, to the first store position using the prefill worker.

19. The data transmission device according to claim 17, wherein the processor is configured to perform following steps:
sending relevant information of a second store position allocated by the prefill worker to the decode worker, the second store position being for storing cached data of the KV cache; and
reading the KV cache from the second store position to the first store position through the RDMA using the decode worker.

20. A non-transitory computer-readable storage medium storing computer instructions, wherein the computer instructions are used to cause a computer to perform a data transmission method, comprising:
calculating Key tensor and Value tensor(KV) cache as a data block to be transmitted using a prefill worker of a machine learning model; and
transmitting, using Remote Direct Memory Access(RDMA), the data block to be transmitted from a Graphics Processing Unit(GPU) of the Prefill worker to a GPU of a decode worker of the machine learning model.
